(19) United States
(12) Patent Application Publication
(10) Pub. No.: US 2025/0144993 A1
(43) Pub. Date: May 8, 2025

(54) FLEXIBLE HYBRID SYSTEM AND GEARBOX

(71) Applicant: Cummins Limited, London (GB)

(72) Inventors: Jacob Harris, Northamptonshire (GB); Neil Graham McNab, Southam (GB)

(73) Assignee: Cummins Limited, London (GB)

(21) Appl. No.: 18/939,348

(22) Filed: Nov. 6, 2024

Related U.S. Application Data
(60) Provisional application No. 63/596,903, filed on Nov. 7, 2023.

(51) Int. Cl. B60K 6/36; B60K 6/387; B60K 6/405

(52) U.S. Cl. CPC B60K 6/36; B60K 6/387; B60K 6/405; B60Y 2200/92

(57) ABSTRACT

A flexible hybrid system is provided. The flexible hybrid system includes a first power source and a gearbox. The gearbox is removably coupled with the first power source. The gearbox includes a flange with a first interface, the first power source removably coupled with the first interface; a housing coupled with the flange, the housing comprising a second interface; and a clutch system disposed at least partially in the housing, the clutch system comprising a first clutch mechanism and a second clutch mechanism. The flexible hybrid system includes a second power source. The second power source is removably coupled with the second interface, wherein the first clutch mechanism is configured to selectively engage the first power source to provide power to the flexible hybrid system; and the second clutch mechanism is configured to selectively engage the second power source to provide power to the flexible hybrid system.

### CROSS-REFERENCE TO RELATED APPLICATIONS

This U.S. patent application claims the benefit of and priority to U.S. Provisional Application No. 63/596,903, filed Nov. 7, 2023, and is incorporated herein by reference in its entirety.

### TECHNICAL FIELD

The present disclosure relates to a flexible hybrid system configured to provide power to a vehicle and to a gearbox of a flexible hybrid system.

### BACKGROUND

Conventional vehicle powertrains have often been powered by gaseous fuels and liquid fuels, such as diesel fuel. While vehicles powered by electricity have many benefits including potential economic and environmental benefits, the electric powered vehicles are not without their challenges. More specifically, electrically powered vehicles may utilize specialized equipment that can increase cost and/or complexity.

### SUMMARY

One embodiment of the present disclosure is directed to a flexible hybrid system for a vehicle. The flexible hybrid system includes a first power source; a gearbox removably coupled with the first power source, the gearbox includes a flange with a first interface, the first power source removably coupled with the first interface; a housing coupled with the flange, the housing comprising a second interface opposite the first interface; and a clutch system disposed at least partially in the housing, the clutch system comprising a first clutch mechanism and a second clutch mechanism; and a second power source, the second power source removably coupled with the second interface, wherein the first clutch mechanism is configured to selectively engage the first power source to provide power to the flexible hybrid system via the first power source; and the second clutch mechanism is configured to selectively engage the second power source to provide power to the flexible hybrid system via the second power source.

One embodiment of the present disclosure is directed to a flexible hybrid system for a vehicle wherein the first power source comprises one of an engine, a battery, or a fuel cell and the second power source comprises an electric machine.

One embodiment of the present disclosure is directed to a flexible hybrid system for a vehicle further comprising a plurality of second power sources including the second power source, wherein the plurality of second power sources are removably coupled with the second interface and are configured to provide a combined power output greater than or equal to a power output of the first power source.

One embodiment of the present disclosure is directed to a flexible hybrid system for a vehicle wherein the gear box further comprises a gear train disposed in the housing. The gear train includes a first gear operably coupled with the first clutch mechanism, wherein actuation of the first clutch mechanism causes the first gear to engage or disengage the first power source, and a second gear operably coupled with the second clutch mechanism, wherein actuation of the second clutch mechanism cause the second gear to engage or disengage the second power source.

One embodiment of the present disclosure is directed to a flexible hybrid system for a vehicle wherein the first clutch mechanism and the second clutch mechanism are independently actuatable from each other.

One embodiment of the present disclosure is directed to a flexible hybrid system for a vehicle wherein the first clutch mechanism and the second clutch mechanism are electromechanical clutch mechanisms configured to actuate responsive to receiving an electrical signal.

One embodiment of the present disclosure is directed to a flexible hybrid system for a vehicle further comprising a plurality of auxiliary components removably coupled with the second interface of the gearbox, the plurality of auxiliary components to be driven by power provided by at least one of the first power source or the second power source.

One embodiment of the present disclosure is directed to a gearbox of a flexible hybrid system of a vehicle. The gearbox includes a housing to removably couple with a first power source and a second power source; a gear train disposed in the housing, the gear train includes a first gear and a second gear operably coupled with the first gear; a first clutch mechanism disposed at least partially in the housing and operably coupled with the first gear to selectively engage the first power source; and a second clutch mechanism disposed at least partially in the housing and operably coupled with the second gear to selectively engage the second power source, the first clutch mechanism and the second clutch mechanism being independently actuatable.

One embodiment of the present disclosure is directed to a gearbox of a flexible hybrid system of a vehicle further comprising a plurality of second gears including the second gear, the plurality of second gears to selectively engage a plurality of second power sources including the second power source, wherein the plurality of second power sources are configured to provide a combined power output greater than or equal to a power output of the first power source.

One embodiment of the present disclosure is directed to a gearbox of a flexible hybrid system of a vehicle further comprising a plurality of second clutch mechanisms including the second clutch mechanism, the first clutch mechanism and each of the plurality of second clutch mechanisms being independently actuatable from each other.

One embodiment of the present disclosure is directed to a gearbox of a flexible hybrid system of a vehicle further comprising a plurality of third gears operably coupled with the first gear, the plurality of third gears to couple with a plurality of auxiliary components of the vehicle, the plurality of auxiliary components to be driven by power provided by at least one of the first power source or the plurality of second power sources.

One embodiment of the present disclosure is directed to a gearbox of a flexible hybrid system of a vehicle wherein the housing comprises a first interface to interface with the first power source and a second interface opposite the first interface. The second interface defines a main drive connector aligned with the first gear, the main drive connector configured to couple a drive component with the gearbox, a power source mount disposed radially outward from the main drive connector, the power source mount configured to couple the second power source with the gearbox, and an auxiliary mount disposed radially outward from the main drive connector, the auxiliary mount configured to couple an auxiliary component with the gearbox.

One embodiment of the present disclosure is directed to a gearbox of a flexible hybrid system of a vehicle further comprising a drive axis, wherein the first gear is centered on the drive axis, and a flange coupled with the housing and centered on the drive axis, the flange comprising a plurality of coupling points disposed adjacent to a perimeter of the flange, the plurality of coupling points disposed substantially equidistant from each other, wherein the flange is configured to rotate about the drive axis to adjust a coupling orientation of the gearbox relative to the first power source.

One embodiment of the present disclosure is directed to a gearbox of a flexible hybrid system of a vehicle wherein the first clutch mechanism and the second clutch mechanism are electromechanical clutch mechanisms configured to actuate responsive to receiving an electrical signal.

One embodiment of the present disclosure is directed to a method of selectively powering a flexible hybrid system via a plurality of power sources. The method includes engaging, via a first clutch mechanism, a first power source of the plurality of power sources to provide power to the flexible hybrid system via the first power source; and engaging, via a second clutch mechanism, a second power source of the plurality of power sources to provide power to the flexible hybrid system via the second power source.

One embodiment of the present disclosure is directed to a method of selectively powering a flexible hybrid system via a plurality of power sources. The flexible hybrid system includes a gearbox comprising a first interface and a second interface. The first power source is coupled with the first interface and the second power source is coupled with the second interface. The flexible hybrid further includes an auxiliary component coupled with the first interface of the gearbox. The method includes providing power to the auxiliary component from at least one of the first power source or the second power source.

One embodiment of the present disclosure is directed to a method of selectively powering a flexible hybrid system via a plurality of power sources. The flexible hybrid system includes a plurality of second power sources, including the second power source. The method includes engaging the plurality of second power sources to provide a combined power output greater than or equal to a power output of the first power source.

One embodiment of the present disclosure is directed to a method of selectively powering a flexible hybrid system via a plurality of power sources. The flexible hybrid system includes a plurality of second power sources, including the second power source. The method includes engaging at least one of the plurality of second power sources to provide a combined power output less than a power output of the first power source.

One embodiment of the present disclosure is directed to a method of selectively powering a flexible hybrid system via a plurality of power sources. The method includes actuating at least one of the first clutch mechanism or the second clutch mechanism responsive to the at least one of the first clutch mechanism or the second clutch mechanism receiving an electrical signal.

One embodiment of the present disclosure is directed to a method of selectively powering a flexible hybrid system via a plurality of power sources, wherein actuating the at least one of the first clutch mechanism or the second clutch mechanism includes actuating the at least one of the first clutch mechanism or the second clutch mechanism independently from each other.

These and other features, together with the organization and manner of operation thereof, will become apparent from the following detailed description when taken in conjunction with the accompanying drawings. This summary is illustrative only and should not be regarded as limiting.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a perspective view of a flexible hybrid system, according to an example embodiment.

FIG. 2 are perspective views of the flexible hybrid system of FIG. 1.

FIG. 3 is a perspective view of a gearbox of the flexible hybrid system of FIG. 1.

FIG. 4 is a perspective view of a gear train disposed in the gearbox of FIG. 3.

FIG. 5 is a perspective view of a gear train of the gearbox of FIG. 3.

FIG. 6 are perspective views of the flexible hybrid system of FIG. 1.

FIG. 7 are perspective views of the flexible hybrid system of FIG. 1.

FIG. 8 is a flow diagram of a method of selectively powering the flexible hybrid system of FIG. 1 via a plurality of power sources, according to an example embodiment.

Reference is made to the accompanying drawings throughout the following detailed description. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Following below are more detailed descriptions of various concepts related to, and implementations of systems and methods of a hybrid electric powertrain without the use of expensive and hard to find equipment. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to various example embodiments, the systems and methods disclosed herein relate to a flexible hybrid system. The flexible hybrid system can be a flexible hybrid system for a vehicle. The flexible hybrid system is configured to drive a powertrain of a vehicle by selectively engaging various types of power sources. The flexible hybrid system includes a gearbox that can attach to at least one first power source (e.g., internal combustion engine, battery pack, fuel cell, etc.) and at least one second power source (e.g., an electric machine). In some embodiments, the flexible hybrid system can include additional power sources. The flexible hybrid system is flexible in that it can selectively engage different power sources based on one or more factors. The factors can include, for example, power requirements, faulty equipment, or environmental factors, among others, or any combination thereof. For example, the flexible hybrid system can engage a first power supply based on a first factor and receive power from the first power supply to power a vehicle. The flexible hybrid system can engage a second power supply based on a second factor and receive power from the second power supply to power a vehicle. The flexible hybrid system can engage any combination of power supplies to receive the desired power. Selectively engaging and disengaging power supplies can be manual (e.g., operator pushes a button or manually engages the power supply) or automatic (e.g., a computing system detects a value or characteristic that exceeds a predetermined threshold and transmits a command signal). Thus, the flexible hybrid system can be a selectively engageable system.

The flexible hybrid system includes a gear train disposed in the gearbox. Each power source can be coupled with the gearbox and be operationally coupled with a corresponding gear of the gear train. The flexible hybrid system also includes a clutch system configured to selectively engage and disengage the power sources such that each power source can be run independently or combined. The selective engagement allows for parallel and series-parallel hybrid system operation. The gearbox can be coupled with the first power source at various orientations. For example, the first power source can be rotated about a drive axis of the gearbox. The coupling of the gearbox with the first power source at a plurality of orientations facilitates suitable packing in an application for geometric or center of gravity benefits.

The flexible hybrid system can be fitted to existing applications for use with one or more preexisting first power sources (e.g., preexisting internal combustion engines). The flexible hybrid system can include a plurality of electric machines to supply power equivalent to the one or more preexisting first power sources.

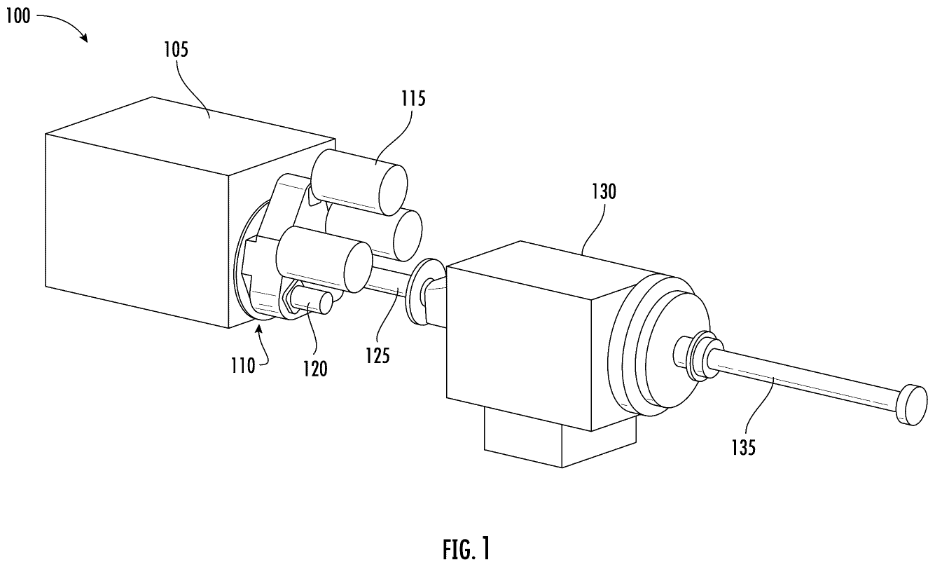

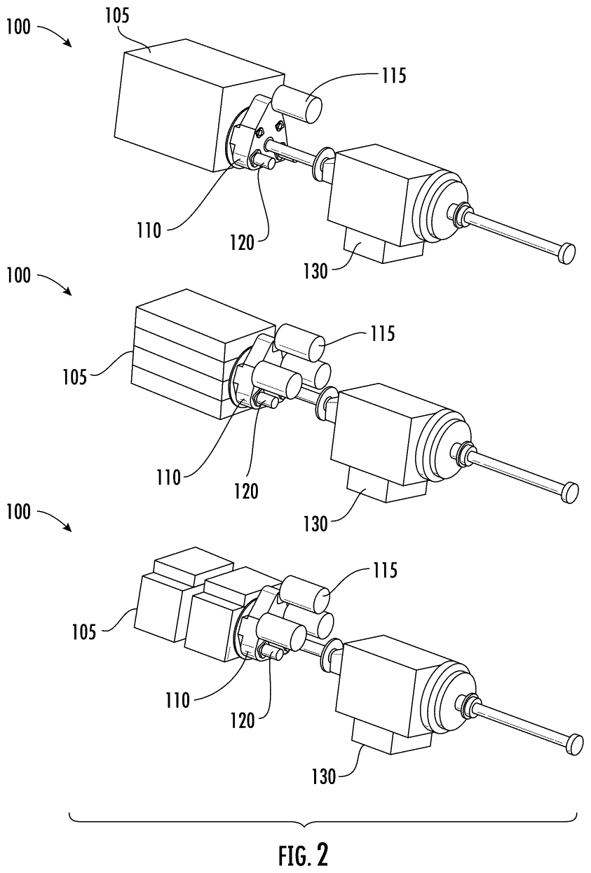

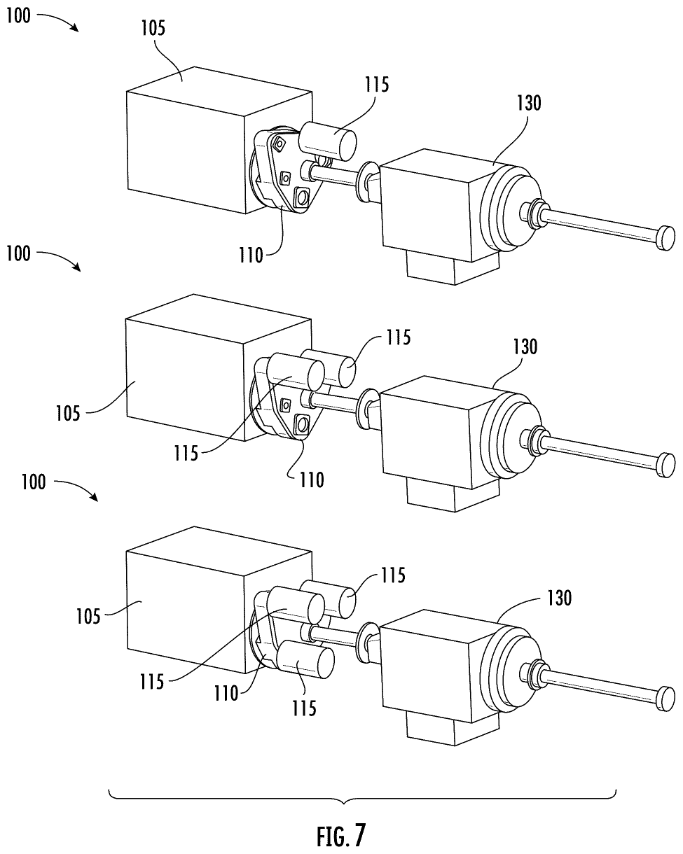

Referring to FIGS. 1 and 2, an example flexible hybrid system 100 is shown, according to example embodiments. The flexible hybrid system 100 can be or can include a powertrain of a vehicle. For example, the flexible hybrid system 100 can provide power from a power source to a driven component. The flexible hybrid system 100 includes at least one power source. The power source can provide power to any number of components coupled with the flexible hybrid system 100. For example, the flexible hybrid system 100 includes at least one first power source 105. The first power source 105 can be any type of power source. For example, as shown in FIG. 7, the first power source 105 can be at least one of an engine (e.g., an internal combustion engine, a diesel engine, a hydrogen-fueled engine, a liquefied petroleum gas engine, an ammonia-fueled engine, a methanol-fueled engine, dual-fueled engine), a battery (e.g., a single battery, a battery pack, etc.), or a fuel cell (e.g., a single fuel, a fuel cell pack, etc.), among others. The flexible hybrid system 100 can include a plurality of first power sources 105. The first power source 105 can provide a power output.

The flexible hybrid system 100 includes at least one gearbox 110. The gearbox 110 can change speed and torque of power transmission, using a set of gears with different sizes and ratios. The gearbox 110 is removably coupled with the first power source 105.

The flexible hybrid system 100 includes at least one second power source 115. The second power source 115 can be any type of power source. For example, the second power source 115 can be an electric machine (e.g., a motor/generator). The second power source 115 can be coupled with the gearbox 110. The second power source 115 can be disposed opposite the first power source 105. The flexible hybrid system 100 can include a plurality of second power sources 115. The plurality of second power sources 115 can be coupled with the gearbox 110.

The plurality of second power sources 115 can be configured to provide a combined power output. In some embodiments, the combined power output of the plurality of second power sources 115 can be less than, greater than, or equal to the power output of the first power source 105. In particular, the combined power output of the plurality of second power sources 115 can either be equivalent to, e.g., within ±10%, or exceed the combined power output of the plurality of second power sources 115. As such, the plurality of second power sources 115 can effectively replace the power provided from the first power source 105. In some embodiments, for example, the combined power output of the plurality of second power sources 115 can be approximately twice or three times that of the first power source 105. In some embodiments, the combined power output of the plurality of second power sources 115 can be less than the power output of the power source 105. For example, the second power sources 115 can be configured to supplement the first power source 105 or be used when less power is demanded. For example, based on the power demand being less than the power capacity of the first power source 105, the flexible hybrid system 100 can engage one or more second power sources 115 such that the power output of the engaged second power source 115, or the combined power output of the engaged second power sources 115, can satisfy the lower power demand.

In some embodiments, the flexible hybrid system 100 includes at least one auxiliary component 120. The auxiliary component 120 can be any component or device that can be receive power provided by at least one of the first power source 105 or the second power source 115. For example, the auxiliary component 120 can be a pump, a motor, or any other device that needs power to operate.

The flexible hybrid system 100 can include at least one drive shaft. For example, the flexible hybrid system 100 can include at least one first drive shaft 125. The first drive shaft 125 can be coupled with the gearbox 110. The power supplied by at least one of the first power source 105 and the second power source 115 can drive the first drive shaft 125. For example, the gearbox 110 can convert the power to a rotational force to rotate the first drive shaft 125.

The flexible hybrid system 100 can include at least one transmission 130. The transmission 130 can be configured to transmit power from at least one of the first power source 105 and the second power source 115 to a driven component (e.g., wheel of a vehicle). The transmission 130 can change speed, torque, and direction of power transmission, using a set of gears with different sizes and ratios. The transmission 130 can be coupled with the first drive shaft 125. The flexible hybrid system 100 can include a second drive shaft 135. The second drive shaft 135 can be coupled with the transmission 130. The transmission 130 can drive the second drive shaft 135 to drive other driven mechanisms coupled with the flexible hybrid system 100.

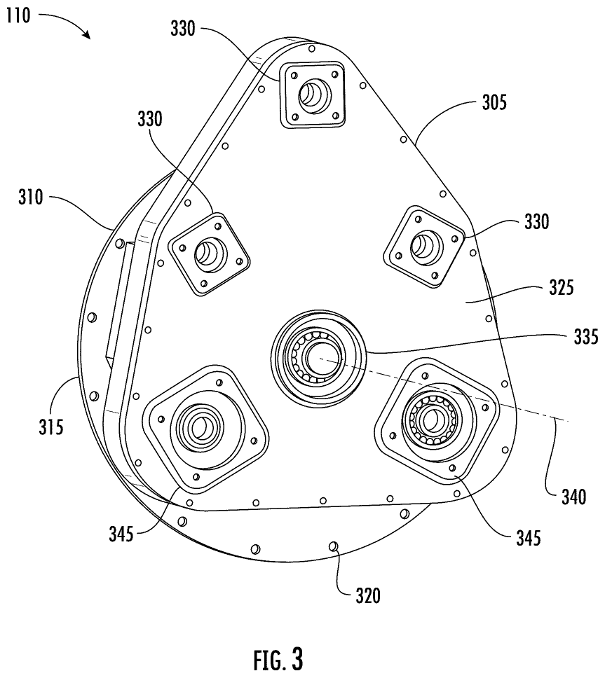

Referring to FIG. 3, a front perspective view of the gearbox 110 is shown, according to an example embodiment. The gearbox 110 includes a housing 305. The housing 305 can be configured to receive or house various components of the gearbox 110. The gearbox 110 includes a flange 310. For example, the housing 305 includes the flange 310. In some embodiments, the housing 305 and the flange 310 are a single piece. In some embodiments, the housing 305 and the flange 310 can be coupled together. For example, the flange 310 can be coupled with or integral with the housing 305. In some embodiments, the housing 305 can include a plurality of flanges 310.

The flange 310 can be configured to couple the gearbox 110 with the first power source 105. The gearbox 110 can be removably coupled with the first power source 105. For example, the flange 310 can have a first side or surface, shown as first interface 315. The first interface 315 can interface with the first power source 105, or a component thereof. The first power source 105 can be removably coupled with the first interface 315. The flange 310 can include a plurality of coupling points 320. The gearbox 110 can be coupled with the first power source 105 via the coupling points 320. The plurality of coupling points 320 can be disposed adjacent to a perimeter of the flange 310. The coupling points can be disposed substantially equidistant from each other such that the flange 310, and therefore the gearbox 110, can be rotated to adjust a coupling orientation of the gearbox 110 relative to the first power source 105. For example, the coupling points 320 can be spaced apart by a distance. The flange 310, and therefore the gearbox 110, can rotate in increments collectively equal to the distance to obtain a desired coupling orientation.

In some embodiments, the gearbox 110 may include no flange. For example, instead, the housing 305 can have the first interface 315 to interface with the first power source 105 to couple the gearbox 110 with the first power source 105. The housing 305 can have a plurality of coupling points 320 such that the housing 305 can be rotated to adjust a coupling orientation of the gearbox 110 relative to the first power source 105.

The housing 305 can be configured to couple the gearbox 110 with at least one second power source 115. The gearbox 110 can be removably coupled with the second power source 115. For example, the housing 305 has a second side or surface, shown as second interface 325. The second interface 325 is opposite the first interface 315. The second interface 325 can interface with the second power source 115. The second power source 115 can be removably coupled with the second interface 325. For example, the second interface 325 can define or include a power source mount 330. The second power source 115 can couple with the gearbox 110 via the power source mount 330. The second interface 325 can define or include a plurality of power source mounts 330. For example, a plurality of second power sources 115 can be coupled with the gearbox 110. Each second power source 115 can have a corresponding power source mount 330.

The housing 305 can be configured to couple the gearbox 110 with at least one drive component (e.g., the first drive shaft 125). For example, the second interface 325 of the gearbox 110 can define or include a main drive connector 335. The drive component can couple with the gearbox 110 via the main drive connector 335 such that power from at least one of the first power source 105 and the second power source 115 can drive the drive component.

The main drive connector 335 defines a drive axis 340. The flange 310 is centered on the drive axis 340. The gearbox 110 can rotate about the drive axis 340 to adjust the coupling orientation of the gearbox 110 relative to the first power source 105.

The housing 305 can be configured to couple the gearbox 110 with at least one auxiliary component 120. For example, the second interface 325 of the gearbox 110 can define or include an auxiliary mount 345. The auxiliary component 120 can couple with the gearbox 110 via the auxiliary mount 345. The second interface 325 can define or include a plurality of auxiliary mounts 345. For example, a plurality of auxiliary components 120 can be coupled with the gearbox 110. Each auxiliary component 120 can have a corresponding auxiliary mount 345. The auxiliary component 120 can couple with the gearbox 110 via the auxiliary mount 345 such that power from at least one of the first power source 105 and the second power source(s) 115 can drive the auxiliary component 120. The auxiliary mount 345 and the power source mount 330 are disposed radially outward from the main drive connector 335.

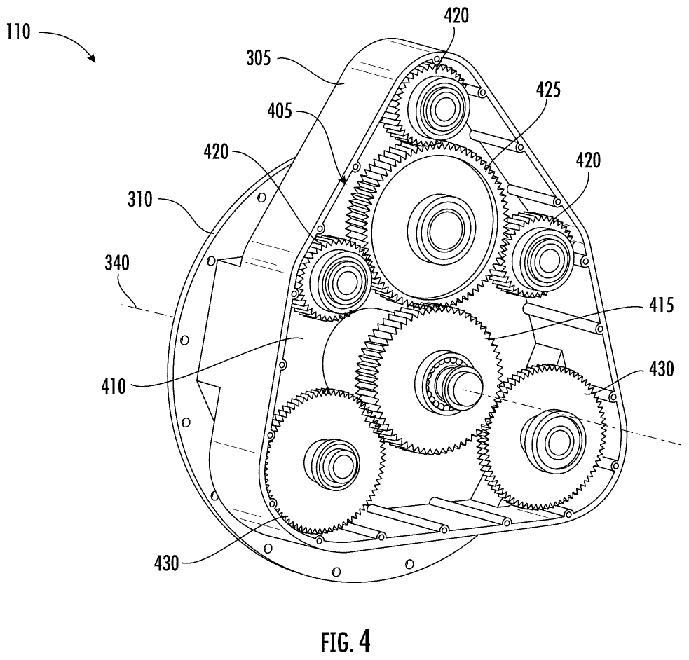

Referring to FIG. 4, the gearbox 110 includes a gear train 405. For example, the housing 305 of the gearbox 110 can define a cavity 410. The gear train 405 can be disposed in the cavity 410 of the housing 305 of the gearbox 110. The gear train 405 includes at least one first gear 415. The first gear 415 can include a single gear or a cluster of gears. The first gear 415 can correspond with and be aligned with the main drive connector 335. For example, the first gear 415 can be centered on the drive axis 340. The first gear 415 can be coaxially aligned with the flange 310. The first gear 415 can be operably coupled with a first power source 105. The first gear 415 can be coupled with a drive component of the flexible hybrid system 100 such that rotation of the first gear 415 can rotate or otherwise drive the drive component. Power from the first power source 105 can drive the first gear 415, and therefore, drive a drive component of the flexible hybrid system 100. Thus, the gearbox 110 can include the drive axis 340, the first gear 415 being centered on the drive axis 340; and the flange 310 coupled with the housing and centered on the drive axis 340, the flange 310 having a plurality of coupling points 320 disposed adjacent to a perimeter of the flange 310, the plurality of coupling points 320 disposed substantially equidistant from each other, and the flange 310 being configured to rotate about the drive axis 340 to adjust a coupling orientation of the gearbox 110 relative to the first power source.

The gear train 405 includes at last one second gear 420. The second gear 420 can be a single gear or a cluster of gears. The second gear 420 can operably couple with a second power source 115. The second gear 420 can correspond with and be aligned with a power source mount 330. The second gear 420 can be operably coupled with the first gear 415 either directly or indirectly. For example, the second gear 420 can be directly operably coupled with the first gear 415 such that the second gear 420 contacts the first gear 415. The second gear 420 can be indirectly operably coupled with the first gear 415 such that there is at least one intermediate gear 425 functionally separating the first gear 415 from the second gear 420. For example, the second gear 420 can contact the intermediate gear 425, and the intermediate gear 425 can contact the first gear 415. Rotation of the second gear 420 can cause rotation of the first gear 415 whether directly or indirectly coupled. Power from the second power source 115 can drive the second gear 420, which can drive the first gear 415, and therefore, drive a drive component of the flexible hybrid system 100.

The gear train 405 can include a plurality of second gears 420. The plurality of second gears 420 can couple with a plurality of second power sources 115. For example, each second gear 420 can couple with a corresponding second power source 115. The plurality of second gears 420 can be directly or indirectly operably coupled with the first gear 415. For example, the gear train 405 can include an intermediate gear 425 to contact the first gear 415. The plurality of second gears 420 can contact the intermediate gear 425. Rotation of at least one of the second gears 420 can cause a rotation of the first gear 415 via rotation of the intermediate gear 425.

The gear train 405 can include at least one third gear 430. The third gear 430 can include a single gear or a cluster of gears. The third gear 430 can correspond with and be aligned with an auxiliary mount 345. The third gear 430 can be operably coupled with an auxiliary component 120. The third gear 430 can be operably coupled with the first gear 415 either directly or indirectly. For example, the third gear 430 can be directly operably coupled with the first gear 415 such that the third gear 430 contacts the first gear 415. The third gear 430 can be indirectly operably coupled with the first gear 415 such that there is at least one intermediate gear 425 functionally separating the first gear 415 from the second gear 420. For example, the third gear 430 can contact the intermediate gear 425, and the intermediate gear 425 can contact the first gear 415. Rotation of the first gear 415 can cause rotation of the third gear 430, whether directly or indirectly coupled. Power from at least one of the first power source 105 or the second power source 115 can drive the first gear 415, which can drive the third gear 430 and therefore drive or provide power to the corresponding auxiliary component 120.

The gear train 405 can include a plurality of third gears 430. The plurality of third gears 430 can couple with a plurality of auxiliary components 120. For example, each third gear 430 can couple with a corresponding auxiliary component 120. The plurality of third gears 430 can be directly or indirectly operably coupled with the first gear 415. For example, the third gears 430 can contact the first gear 415. Rotation of at least one of the first gear 415 can cause a rotation of the third gears 430.

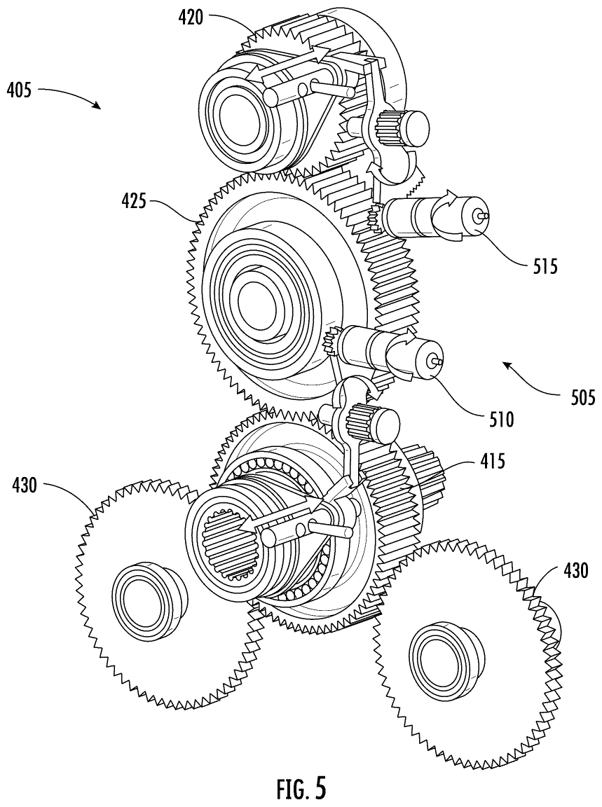

Referring to FIG. 5, a front perspective view of the gear train 405 is shown, according to an example embodiment. The gear train 405 can include or be operably coupled with a clutch system 505. The clutch system 505 can be at least partially disposed in the housing 305 of the gearbox 110. The clutch system 505 can selectively engage (and disengage) at least one of the first and second power sources 105, 115 to modulate between which of the first and second power sources 105, 115 provide power to the flexible hybrid system 100. The clutch system 505 facilitates flexibility within the flexible hybrid system 100 such that power can be provided by various sources or combinations of sources based on system requirements (e.g., how much power needed, duration of power needed, etc.). The clutch system 505 includes at least one first clutch mechanism 510. The first clutch mechanism 510 can be at least partially disposed in the housing 305. The first clutch mechanism 510 can be an electromechanical clutch mechanism configured to actuate responsive to receiving an electrical signal. The electrical signal can be manually generated or automatically generated. For example, in some embodiments, a user or operator of a vehicle can actuate a button to activate the first clutch mechanism 510 to engage or disengage the first clutch mechanism 510. In some embodiments, a computing system may monitor the vehicle or the flexible hybrid system 100 and generate a signal to engage or disengage the first clutch mechanism 510 based on a monitored value or characteristic reaching a predetermine threshold. The first clutch mechanism 510 can selectively engage the first power source 105 to provide power to the flexible hybrid system 100 via the first power source 105. For example, the first clutch mechanism 510 can be operably coupled with the first gear 415. Actuation of the first clutch mechanism 510 can cause the first gear 415 to engage or disengage the first power source 105. With the first gear 415 engaged with the first power source 105, the first power source 105 can drive the first gear 415, which can drive a drive component. With the first gear 415 disengaged from the first power source 105, the first power source 105 cannot drive the first gear 415.

The clutch system 505 includes at least one second clutch mechanism 515. The second clutch mechanism 515 can be at least partially disposed in the housing 305. The second clutch mechanism 515 can be an electromechanical clutch mechanism configured to actuate responsive to receiving an electrical signal, similar to the first clutch mechanism 510. The second clutch mechanism 515 can selectively engage the second power source 115 to provide power to the flexible hybrid system 100 via the second power source 115. For example, the second clutch mechanism 515 can be operably coupled with a second gear 420. Actuation of the second clutch mechanism 515 can cause the second gear 420 to engage or disengage the second power source 115. With the second gear 420 engaged with the second power source 115, the second power source 115 can drive the second gear 420, which can drive the first gear 415 (e.g., directly or indirectly), which can drive a drive component. With the second gear 420 disengaged from the second power source 115, the second power source 115 cannot drive the second gear 420, and therefore cannot drive the first gear 415. In some embodiments, the second clutch mechanism 515 can be operably coupled with a plurality of second gears 420. For example, the flexible hybrid system 100 can include a plurality of second power sources 115 operably coupled with a plurality of second gears 420. The second clutch mechanism 515 can be operably coupled with the plurality of second gears 420 to selectively engage and disengage the plurality of second power sources 115.

The first clutch mechanism 510 and the second clutch mechanism 515 can be independently actuatable from each other. For example, the first clutch mechanism 510 can engage the first gear 415 with the first power source 105 with the second gear 420 disengaged from the second gear 420 such that only the first power source 105 can provide power to the flexible hybrid system 100. The second clutch mechanism 515 can engage the second gear 420 with the second power source 115 with the first gear 415 disengaged from the first power source 105 such that only the second power source 115 can provide power to the flexible hybrid system 100. The first clutch mechanism 510 can engage the first gear 415 with the first power source 105 and second clutch mechanism 515 can engage the second gear 420 with the second power source 115 simultaneously such that both the first power source 105 and the second power source 115 can provide power to the flexible hybrid system.

The clutch system 505 can include a plurality of second clutch mechanisms 515. For example, the flexible hybrid system 100 can include a plurality of second power sources 115. The gearbox 110 can include a plurality of second gears 420. Each second power source 115 of the plurality of second power sources 115 can be operably coupled with a second gear 420 of the plurality of second gears 420. Each of the plurality of second gears 420 can be operably coupled with a second clutch mechanism 515 of the plurality of second clutch mechanisms 515. Each second clutch mechanism 515 can be coupled with a subset of the plurality of second gears 420. For example, each second gear 420 can have an independent second clutch mechanism 515. The plurality of second clutch mechanisms 515 can be independently actuatable. For example, the plurality of second clutch mechanisms 515 can be independently actuatable such that each second gear 420 can be individually engaged or disengaged from a respective second power source 115. For example, the plurality of second clutch mechanisms 515 can be actuated such that all of the second power sources 115 are engaged with a respective second gear 420, none of the second power sources 115 are engaged with a respective second gear 420, or a subset of the second power sources 115 are engaged with a respective second gear 420.

The first clutch mechanism 510 and each of the plurality of second clutch mechanisms 515 can be independently actuatable. Thus, the first clutch mechanism 510 can be actuated without any of the second clutch mechanisms 515 being actuated, and vice versa. For example, any combination of first gears 415 and second gears 420 can be engaged and disengaged at a certain time. For example, a first gear 415 can engage the first power source 105 and a plurality of second gears 420 can engage a plurality of second power sources 115 simultaneously. A first gear 415 can engage the first power source 105 and a subset of a plurality of second gears 420 can engage a subset of a plurality of second power sources 115 simultaneously.

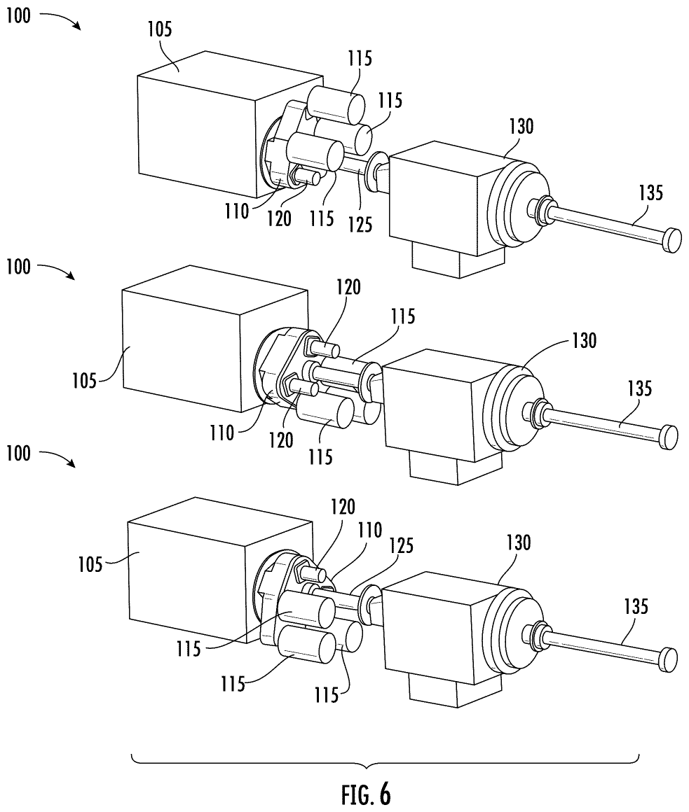

Referring to FIG. 6, perspective views of the flexible hybrid system 100 are shown, according to an example embodiment. The gearbox 110 has a coupling orientation when coupled with the first power source 105. As mentioned above, the coupling orientation can be adjusted to, for example, facilitate suitable packing in an application for geometric or center of gravity benefits. The gearbox 110 can be rotated around the drive axis 340 to obtain the desired coupling orientation of the gearbox 110. For example, the gearbox 110 can be oriented such that the power source mounts 330 are disposed above the main drive connector 335 and the auxiliary mounts 345 are disposed below the main drive connector 335. The gearbox 110 can be oriented such that the power source mounts 330 are disposed below the main drive connector 335 and the auxiliary mounts 345 are disposed above the main drive connector 335. The gearbox 110 can be oriented at any angle around the drive axis 340.

Referring to FIG. 7, perspective views of the flexible hybrid system 100 are shown, according to an example embodiment. The gearbox 110 can be configured to couple with any number of second power sources 115. For example, the gearbox 110 can couple with one, two, three, four, or five second power sources 115, among others. As such, the gearbox 110 can define or include any number of power source mounts 330. For example, the gearbox 110 can define or include one or a plurality of power source mounts 330, among others. For example, in some embodiments, the gearbox 110 can define one, two, three, four, or five power source mounts 330, among others. The second power sources 115 can be removably coupled with the gearbox 110 such that the number of second power sources 115 coupled with the gearbox 110 can be variable.

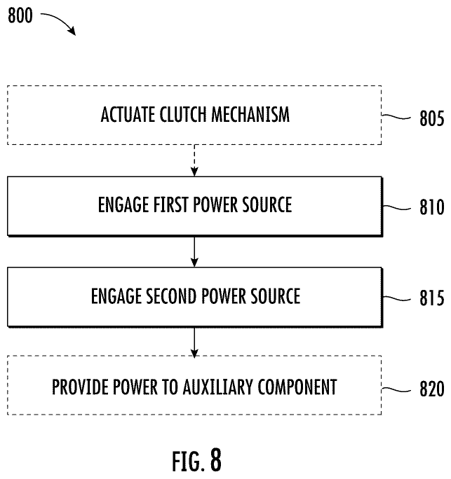

Referring to FIG. 8, a flow diagram of an example method 800 of selectively powering a flexible hybrid system 100 via a plurality of power sources is shown, according to an example embodiment. In some embodiments, method 800 can include actuating a clutch mechanism (step 805). For example, the flexible hybrid system 100 can include a first clutch mechanism 510 and a second clutch mechanism 515. Step 805 can include actuating at least one of the first clutch mechanism 510 or the second clutch mechanism 515 responsive to at least one of the first clutch mechanism 510 or the second clutch mechanism 515 receiving an electrical signal. In some embodiments, actuating the at least one of the first clutch mechanism 510 or the second clutch mechanism 515 includes actuating the at least one first clutch mechanism 510 or the second clutch mechanism 515 independently from each other.

Method 800 includes engaging a first power source 105 of a plurality of power sources (step 810). For example, the flexible hybrid system 100 can include a gearbox 110. The gearbox 110 can include a first interface 315 and a second interface 325. The first power source 105 can be coupled with the first interface 315 and the second power source 115 can be coupled with the second interface 325. The flexible hybrid system 100 engages the first power source 105 via the first clutch mechanism 510. Engaging the first power source 105 via the first clutch mechanism 510 provides power to the flexible hybrid system 100 via the first power source 105.

Method 800 includes engaging a second power source 115 of the plurality of power sources (step 815). For example, the flexible hybrid system 100 engages the second power source 115 via the second clutch mechanism 515. Engaging the second power source 115 via the second clutch mechanism provides power to the flexible hybrid system 100 via the second power source 115.

In some embodiments, the flexible hybrid system 100 includes a plurality of second power sources 115. Step 815 can include engaging the plurality of second power sources 115 to provide a combined power output greater than or equal to a power output, or the power output capacity, of the first power source 105. In some embodiments, step 815 an include engaging at least one of the plurality of second power sources 115 to provide a combined power output that is less than the power output, or the power output capacity, of the first power source 105.

In some embodiments, method 800 can include providing power to at least one auxiliary component 120 (step 820). For example, an auxiliary component 120 can be coupled with the second interface 325 of the gearbox 110. Step 820 can include providing power to the auxiliary component from at least one of the first power source 105 or the second power source 115. In some embodiments, a plurality of auxiliary components 120 can be coupled with the gearbox 110. Step 820 can include providing power to the plurality of auxiliary components 120 from at least one of the first power source 105 or the second power source 115.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical and/or electrical, for example.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the flexible hybrid system 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A flexible hybrid system for a vehicle, comprising:
a first power source;
a gearbox removably coupled with the first power source, the gearbox comprising:
a flange with a first interface, the first power source removably coupled with the first interface;
a housing including the flange, the housing comprising a second interface opposite the first interface; and
a clutch system disposed at least partially in the housing, the clutch system comprising a first clutch mechanism and a second clutch mechanism; and
a second power source, the second power source removably coupled with the second interface, wherein:
the first clutch mechanism is configured to selectively engage the first power source to provide power to the flexible hybrid system via the first power source; and
the second clutch mechanism is configured to selectively engage the second power source to provide power to the flexible hybrid system via the second power source.

2. The flexible hybrid system of claim 1, wherein:
the first power source comprises one of an engine, a battery, or a fuel cell; and
the second power source comprises an electric machine.

3. The flexible hybrid system of claim 1, further comprising:
a plurality of second power sources including the second power source, wherein the plurality of second power sources are removably coupled with the second interface and are configured to provide a combined power output greater than or equal to a power output of the first power source.

4. The flexible hybrid system of claim 1, wherein the gearbox further comprises:
a gear train disposed in the housing, the gear train comprising:
a first gear operably coupled with the first clutch mechanism, wherein actuation of the first clutch mechanism causes the first gear to engage or disengage the first power source; and
a second gear operably coupled with the second clutch mechanism, wherein actuation of the second clutch mechanism cause the second gear to engage or disengage the second power source.

5. The flexible hybrid system of claim 4, wherein the first clutch mechanism and the second clutch mechanism are independently actuatable from each other.

6. The flexible hybrid system of claim 5, wherein the first clutch mechanism and the second clutch mechanism are electromechanical clutch mechanisms configured to actuate responsive to receiving an electrical signal.

7. The flexible hybrid system of claim 1, further comprising a plurality of auxiliary components removably coupled with the second interface of the gearbox, the plurality of auxiliary components to be driven by power provided by at least one of the first power source or the second power source.

8. A gearbox of a flexible hybrid system of a vehicle, comprising:
a housing to removably couple with a first power source and a second power source;
a gear train disposed in the housing, the gear train comprising:
a first gear; and
a second gear operably coupled with the first gear;
a first clutch mechanism disposed at least partially in the housing and operably coupled with the first gear to selectively engage the first power source; and
a second clutch mechanism disposed at least partially in the housing and operably coupled with the second gear to selectively engage the second power source, the first clutch mechanism and the second clutch mechanism being independently actuatable.

9. The gearbox of claim 8, further comprising a plurality of second gears including the second gear, the plurality of second gears to selectively engage a plurality of second power sources including the second power source, wherein the plurality of second power sources are configured to provide a combined power output greater than or equal to a power output of the first power source.

10. The gearbox of claim 9, further comprising a plurality of second clutch mechanisms including the second clutch mechanism, the first clutch mechanism and each of the plurality of second clutch mechanisms being independently actuatable from each other.

11. The gearbox of claim 10, further comprising a plurality of third gears operably coupled with the first gear, the plurality of third gears to couple with a plurality of auxiliary components of the vehicle, the plurality of auxiliary components to be driven by power provided by at least one of the first power source or the plurality of second power sources.

12. The gearbox of claim 8, wherein the housing comprises:
a first interface to interface with the first power source; and
a second interface opposite the first interface, the second interface defining:
a main drive connector aligned with the first gear, the main drive connector configured to couple a drive component with the gearbox;
a power source mount disposed radially outward from the main drive connector, the power source mount configured to couple the second power source with the gearbox; and
an auxiliary mount disposed radially outward from the main drive connector, the auxiliary mount configured to couple an auxiliary component with the gearbox.

13. The gearbox of claim 8, further comprising:
a drive axis, wherein the first gear is centered on the drive axis; and
a flange coupled with the housing and centered on the drive axis, the flange comprising a plurality of coupling points disposed adjacent to a perimeter of the flange, the plurality of coupling points disposed substantially equidistant from each other, wherein the flange is configured to rotate about the drive axis to adjust a coupling orientation of the gearbox relative to the first power source.

14. The gearbox of claim 8, wherein the first clutch mechanism and the second clutch mechanism are electromechanical clutch mechanisms configured to actuate responsive to receiving an electrical signal.

15. A method of selectively powering a flexible hybrid system via a plurality of power sources, the method comprising:
engaging, via a first clutch mechanism, a first power source of the plurality of power sources to provide power to the flexible hybrid system via the first power source; and
engaging, via a second clutch mechanism, a second power source of the plurality of power sources to provide power to the flexible hybrid system via the second power source.

16. The method of claim 15, wherein the flexible hybrid system comprises:
a gearbox comprising a first interface and a second interface, the first power source coupled with the first interface and the second power source coupled with the second interface; and
an auxiliary component coupled with the second interface of the gearbox;
the method further comprising:
providing power to the auxiliary component from at least one of the first power source or the second power source.

17. The method of claim 15, wherein the flexible hybrid system comprises a plurality of second power sources, including the second power source, the method further comprising:
engaging the plurality of second power sources to provide a combined power output greater than or equal to a power output of the first power source.

18. The method of claim 15, wherein the flexible hybrid system comprises a plurality of second power sources, including the second power source, the method further comprising:
engaging at least one of the plurality of second power sources to provide a combined power output less than a power output of the first power source.

19. The method of claim 15, further comprising:
actuating at least one of the first clutch mechanism or the second clutch mechanism responsive to the at least one of the first clutch mechanism or the second clutch mechanism receiving an electrical signal.

20. The method of claim 19, wherein actuating the at least one of the first clutch mechanism or the second clutch mechanism comprises actuating the at least one of the first clutch mechanism or the second clutch mechanism independently from each other.
